(19) United States
(12) Patent Application Publication
(10) Pub. No.: US 2016/0196100 A1
(43) Pub. Date: Jul. 7, 2016

(54) HEADPHONES HAVING AN ATTACHED SOUND MODULE

(71) Applicant: AFC TRIDENT, INC., Ontario, CA (US)

(72) Inventors: Hong Lip YOW, Chino, CA (US); Sam PYO, La Habra, CA (US); Roberto LUNA, Riverside, CA (US)

(21) Appl. No.: 14/588,895

(22) Filed: Jan. 2, 2015

(51) Int. Cl. G06F 3/16; H04R 1/10

(52) U.S. Cl. CPC G06F 3/162; H04R 1/1041

(57) ABSTRACT

Provided is a headphone system, comprising a sound module and a headphone body. The sound module comprises a module attachment interface, a module audio interface, and a controller. The headphone body comprises a first earphone; a second earphone; and a headphone attachment interface to provide removable attachment with the module attachment interface a headphone audio interface to couple with the module audio interface when the module attachment interface is engaged with the headphone attachment interface. The headphone audio interface communicates audio signals from the sound module to the first earphone and the second earphone when the module attachment interface is engaged with the headphone attachment interface. The controller transmits audio signals from the sound module to the module audio interface to further transmit to the headphone audio interface which transmits to at least one of the first and second earphones via the headphone audio interface.

### BACKGROUND OF THE INVENTION

1. Field of the Invention

The present invention relates to a headphone apparatus, headphone system and sound module for removable attachment to headphones.

2. Description of the Related Art

Headphones may be used to provide different functionality. For instance, some headphones may have controls for controlling the playing of audio from an externally connected device, such as a smartphone, media player, etc. Other types of headphones for gaming may include a microphone to allow a user to transmit voice audio to an external gaming system and receive audio transmitted from the external gaming system. Other types of headphones may be used by the user to communicate by voice with an external device, such as a phone or computer.

### SUMMARY

Provided is a headphone apparatus to connect with a sound producing module, comprising a first earphone; a second earphone; an attachment interface to provide removable attachment with the sound module; an audio interface to couple with the sound module when the sound module is coupled to the attachment interface; an audio communication interface electrically coupled to the first earphone, the second earphone, and the audio interface to communicate audio signals from the sound module coupled to the attachment interface and the audio interface.

Further provided is a headphone system, comprising a sound module and a headphone body. The sound module comprises a module attachment interface, a module audio interface, and a controller. The headphone body comprises a first earphone; a second earphone; and a headphone attachment interface to provide removable attachment with the module attachment interface a headphone audio interface to couple with the module audio interface when the module attachment interface is engaged with the headphone attachment interface. The headphone audio interface communicates audio signals from the sound module to the first earphone and the second earphone when the module attachment interface is engaged with the headphone attachment interface and when the module audio interface is electrically coupled to the headphone audio interface. The controller of the sound module causes operations comprising transmitting audio signals from the sound module to the module audio interface to further transmit to the headphone audio interface which transmits to at least one of the first and second earphones via the headphone audio interface.

Further provided is a sound module for coupling with a headphone having a first earphone, a second earphone, a headphone attachment interface and a headphone audio interface. The sound module comprises: a sound module attachment interface designed to removably attach to the headphone attachment interface; a sound module audio interface to couple with the headphone audio interface when the sound module attachment interface is engaged with the headphone attachment interface; a module audio source for producing audio signals; and a controller. The controller performs operations comprising transmitting audio signals from the module audio source through the sound module audio interface to the headphone audio interface to transmit to at least one of the first and second earphones.

Further provided is a headphone system, comprising a sound module, a headphone body, and at least one external microphone. The sound module comprises a module interface; a controller; a user interface enabling selection of one of a first setting and a second setting; and a module audio source to generate audio signals. The headphone body comprises a first earphone; a second earphone; a headphone audio interface to couple with the module audio interface, the first earphone, the second earphone, to communicate audio signals from the sound module. The at least one external microphone is located on at least one of the sound module and the headphone body. The at least one external microphone transmits sounds from an environment external to the headphone system to the sound module. The controller of the sound module performs operations comprising receiving audio signals from the module audio source and the external microphone and selecting to transmit audio signals from one of the module audio source or the external microphone to transmit to at least one of the first and second earphones via the module audio interface.

### BRIEF DESCRIPTION OF THE DRAWINGS

Embodiments are described by way of example, with reference to the accompanying drawings, which are not drawn to scale, wherein:

FIGS. 1a, 1b, and 1c illustrate an embodiment of a headset and removably attachable sound module.

FIGS. 2a, 2b, 2c, 3, 4a, 4b, and 4c illustrate embodiments of removably attachable sound modules.

FIG. 5 illustrates an embodiment of components of a headset.

FIG. 6 illustrates an embodiment of components of a sound module.

FIG. 7 illustrates an embodiment of operations to select audio from an auxiliary audio source or a module audio source to transmit to earphones according to user selection.

### DETAILED DESCRIPTION

In current art, if a user wants to use headphones for different purposes, then the user may have to have multiple headphone sets for the different purposes. For instance, the user may have headphones for connecting to an external device, such as a media player, smartphone, computer, etc. and separate headphones allowing for the user to transmit voice audio to a connected gaming system or phone.

Described embodiments provide a headphone apparatus and sound modules that may removably attach to the headphone apparatus. Described embodiments provide sound modules for different purposes, such as a sound module to play audio files stored in the sound module memory or a flash memory card inserted in the sound module, a sound module for controlling the playing of audio files in an external audio media player, and a yet further sound module having a microphone to allow the user to transmit voice communication to the external device and headphones. The user may removably attach the different sound modules to the headphones depending on the desired functionality. In this way, the user may use a single set of headphones for different purposes by attaching different sound modules.

Further, described embodiments allow the user to select, through a user interface on the sound module, to transmit audio to the earphones of the headphones from either a sound module audio source or an auxiliary audio source, such as a headphone audio source (e.g., headphone microphone on the headphone body). When the user selects one of the auxiliary or sound module audio sources, the controller of the sound module may only transmit audio signals from the selected auxiliary or module audio source to the earphones and block or prevent transmission of audio signals from the audio source not selected.

Reference below will be made to the drawings wherein like structures may be provided with like reference designations. In order to show the structures of various embodiments most clearly, the drawings included herein include diagrammatic representations of components of the described embodiments. Thus, the actual appearance of the embodiments may appear different while still incorporating the claimed structures of the illustrated embodiments. Moreover, the drawings may show only the structures necessary to understand the illustrated embodiments. Additional structures known in the art have not been included to maintain the clarity of the drawings.

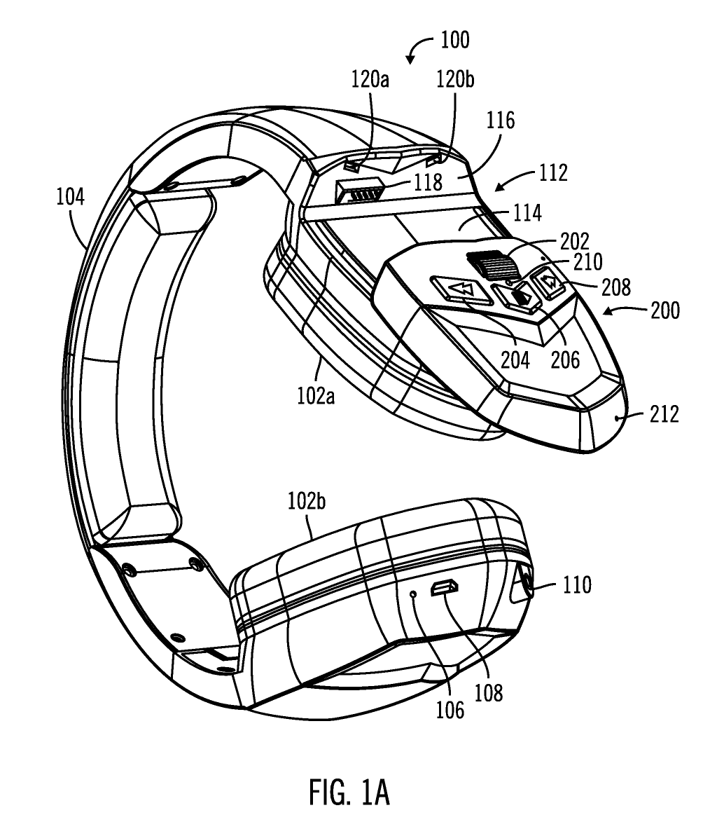

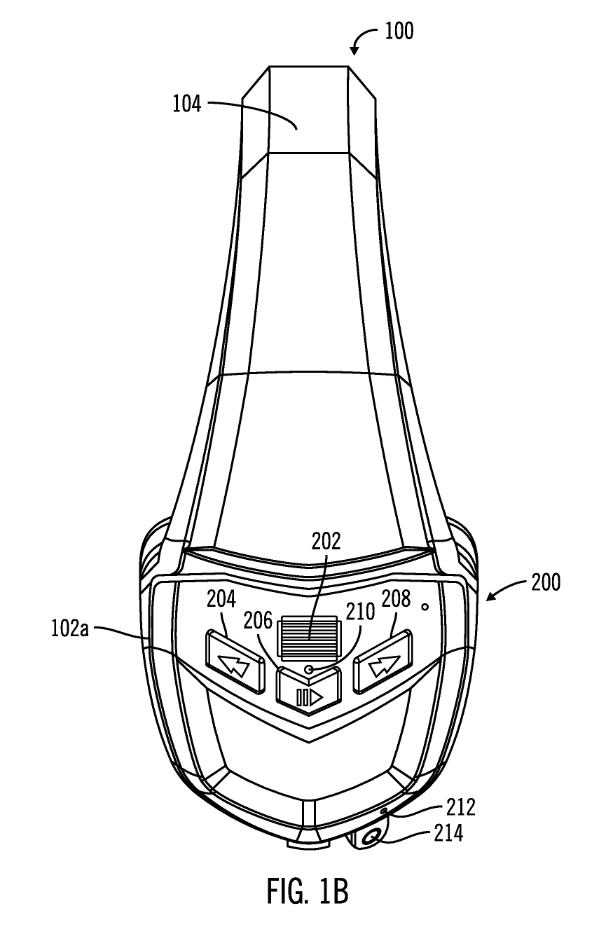

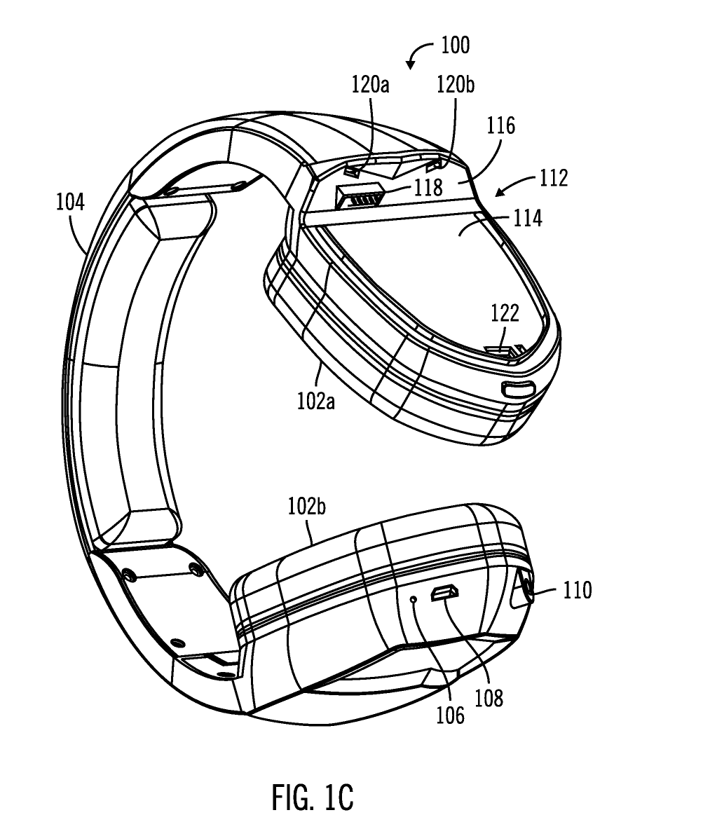

FIGS. 1a, 1b, and 1c illustrate different views of an embodiment of headphones 100 having two earphones 102a, 102b, also known as speakerphones, intended to cover the ears of the user to provide audio signals to the user wearing the headphone 100. A headband 104 or bridge structure connects the two earphones 102a, 102b. Earphone 102a body may also optionally include a headphone external microphone 106 to receive audio from an environment external to the headphone 100, a charging port 108, e.g., a micro-USB port, to receive power to charge a battery in the headphones 100, and a port 110 to receive audio signals, such as a 3.5 mm audio jack, from an external device rendering audio.

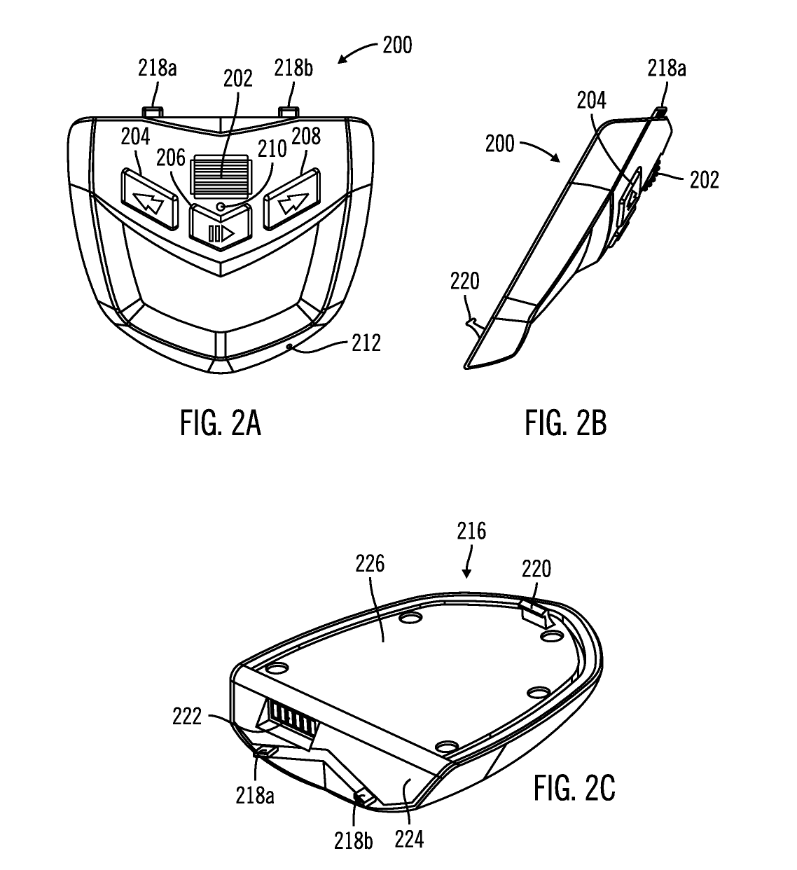

FIG. la further shows a removable sound module 200 that is removably attachable to a headphone attachment interface 112 of the earphone 102a body. FIG. 1b shows the sound module 200 fully engaged and attached in position with respect to the headphone attachment interface 112 of the earphone body 102a. The headphone attachment interface 112 (FIGS. 1a and 1c) includes a relatively flat upper surface 114 and a side wall 116 orthogonal with respect to the upper surface 114 to which the sound module 200 may be removably attached. The side wall 116 has a headphone audio interface 118 with connector pins to transmit audio signals generated from within the sound module 200 to at least one of the earphones 102a, 102b. As shown in FIGS. 1a and 1c, the headphone attachment interface 112 includes side wall slots 120a, 120b and a surface slot 122 that mate with attachment clips 218a, 218b on a side wall 224 of the sound module 200 and with an attachment clip 220 on a bottom surface 226 of the sound module as shown in FIGS. 2a, 2b, 2c. This mating of the slots 120a, 120b, 122 and clips 218a, 218b, 220 allows for mechanical removable attachment of the sound module 200 to the upper surface 114 of the earphone body 102a.

As shown in FIGS. 1a, 1b, 1c, 2a, 2b, 2c, the sound module 200 includes various user interface controls including, by way of example, a scrollable wheel button 202 and reverse 204, pause/play 206, and forward 208 audio controls to control audio content being played by the sound module 200. The wheel button 202 may be rotated in different directions to increase or decrease volume of the audio content being produced by the sound module 200 and may be depressed to wirelessly connect to an external device. A display indicator 210, such as a light emitting diode (LED) indicator, may illuminate to indicate connection to a remote external device, such as a multimedia player, smartphone, audio music player, computer, etc., via a wireless connection interface such as Bluetooth®. (Bluetooth is a trademark registered throughout the world to Bluetooth SIG, Inc.).

The sound module 200 may include an external microphone 212 (FIG. 1b, 2a) to transmit sounds in the environment external to the headphone 104 to the sound module 200. The sound module 200 may further include a data port 214 in addition to the microphone 212 as shown in FIG. 1b. In one embodiment, the data port 214 may allow connection with an external device to allow audio signals to be communicated between the external device, such as a smartphone, game console, computer, etc., and the sound module 200. Alternatively, the data port 214 may be used to upload audio files into the sound module 200.

The sound module 200 further includes a module attachment interface 216 (FIG. 2c) to allow the sound module 200 to attach and be removed from engaging with the headphone attachment interface 112. As shown in FIGS. 2a, 2b, 2c, the module attachment interface 216 comprises attachment clips 218a, 218b on a sidewall 224 of the sound module 200 and attachment clip 220 on a bottom surface 226 of the sound module 200 that engage and are inserted into the slots 120a, 120b and 122 of the headphone attachment interface 112 to mechanically attach and couple the sound module 200 to the headphone 100. The sound module further has a module audio interface 222 having female connectors to engage the pins of the headphone audio interface 118 to allow the communication of audio signals between the sound module 200 and the headphone 100 components such as the earphones 102a, 102b and headphone microphone 106. In certain embodiments, wires connect the earphones 102a, 102b and headphone microphone 106 to the headphone audio interface 118 to allow audio and electrical coupling with the sound module 200 via the module audio interface 222.

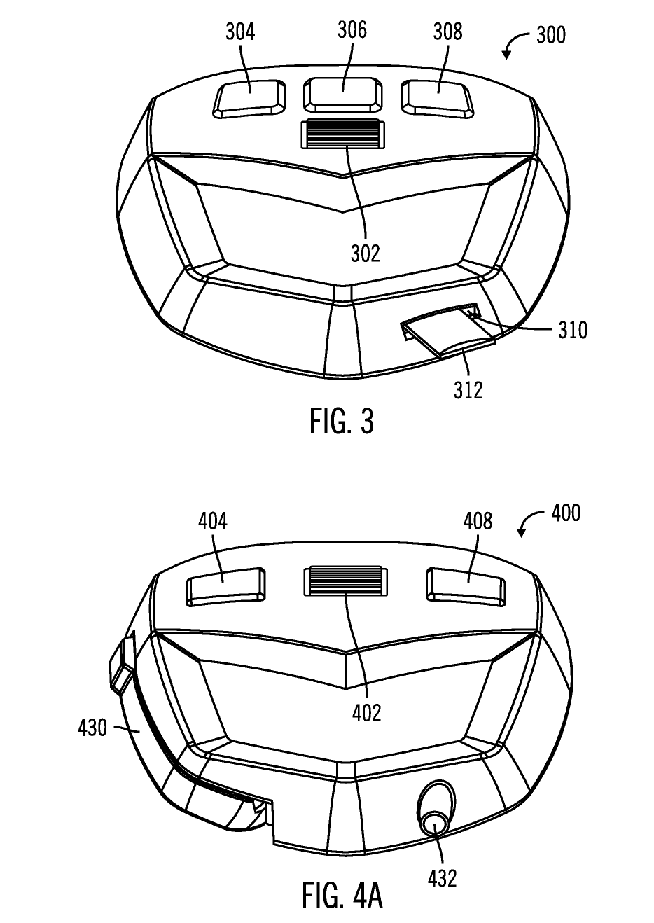

FIG. 3 illustrates an alternative embodiment of a sound module 300 having audio control buttons 302, 304, 306, and 308, such as described with respect to the audio control buttons 202, 204, 206, and 208 in FIGS. 1a, 1b, 2a, 2b, 2c. The sound module 300 further includes a card reader port 310 to read an inserted flash memory card 312, such a CompactFlash (CF), SmartMedia, MultiMediaCard (MMC), Secure Digital (DS), Memory Stick, and other type of flash memory card or removable storage device. The audio control buttons 302, 304, 306, and 308 may be used to control the playing of audio content on the flash memory card 312. The sound module 300 may have a module attachment interface 216 and module audio interface 222 such as described with respect to FIGS. 2a, 2b, 2c. The sound module 300 may removably attach and mechanically engage the headphone attachment interface 112 as described with respect to the sound module 200.

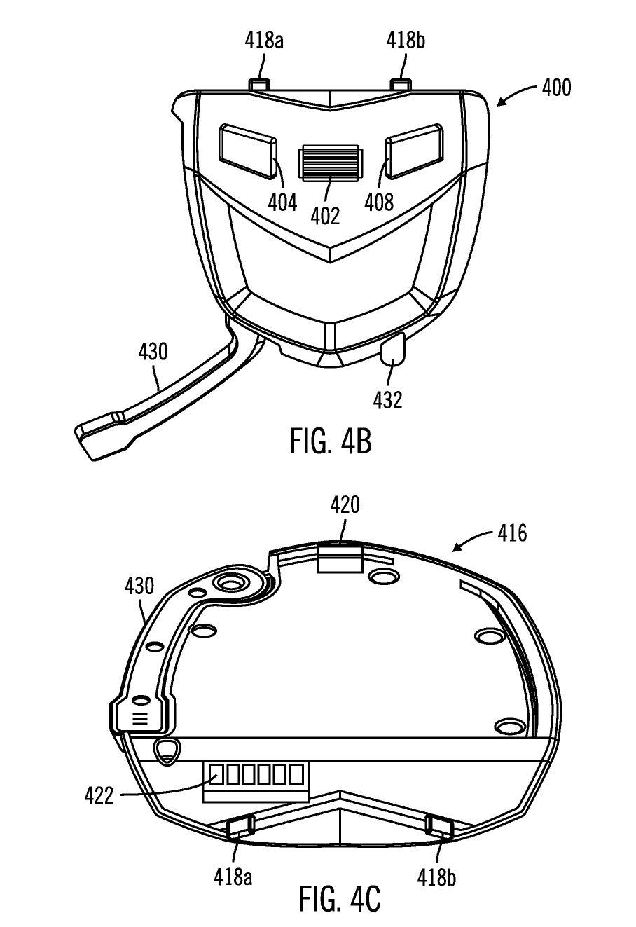

FIGS. 4a, 4b, and 4c illustrate an alternative embodiment of a sound module 400. The sound module 400 may have audio control buttons 402, 404, and 408 such as described with respect to the audio control buttons 202, 204, and 208 described with respect to FIGS. 1a, 1b, 2a, 2b, 2c. The sound module 400 may have a module audio interface 422 (FIG. 4c) and module attachment structure 416 having clips 418a, 418b, and 420 such as described with respect to the module audio interface 222 and module attachment structure 216, 218a, 281b, and 220 in FIGS. 1a, 1b, 2a, 2b, 2c.

The sound module 400 further includes a retractable microphone boom 430 that may be manually rotated to extend as shown in FIG. 4b or retract as shown in FIGS. 4a and 4b. The scroll wheel button 406 may be depressed to switch between transmitting audio signals to the headphone 100 from the microphone boom 430 or the headphone microphone 106. The sound module 400 may further include a wire out port 432 to allow data transmission with an external device, such as a game console, smartphone, multi-media player, etc.

In the described embodiments, the sound module 400 is removably attachable with the headphones 100 through the attachment interfaces 112 and 216. In an alternative embodiment, the sound module 400 may not be removably attachable and may instead be attached to the headphone 100 in a non-removable manner or manufactured integrated with the headphones 100.

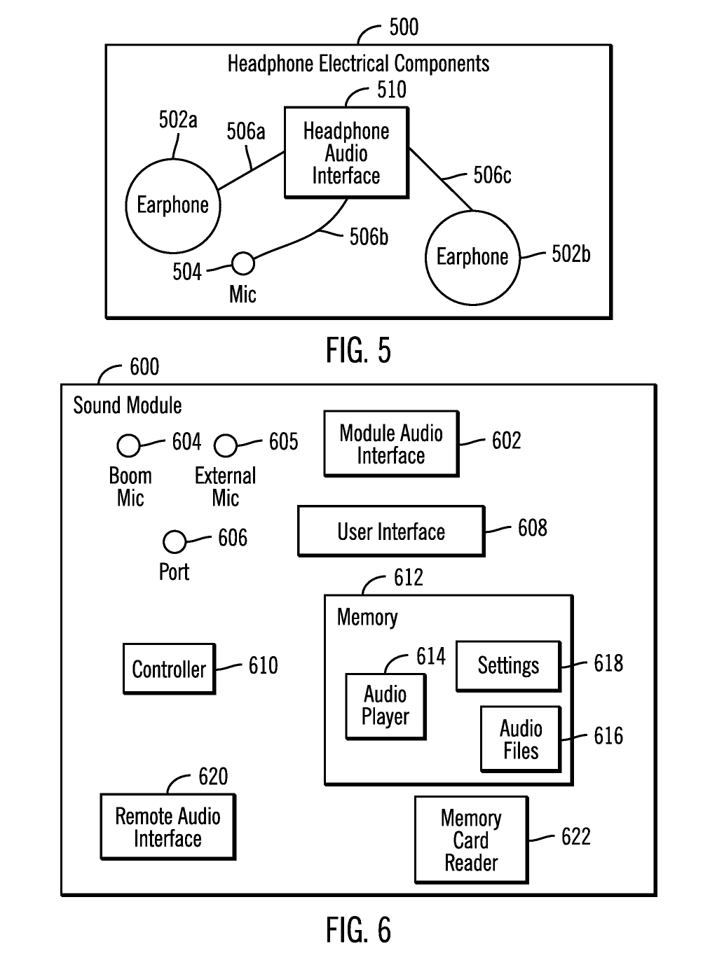

FIG. 5 illustrates an embodiment of the headphone electrical components 500 included in the headphone 100, including earphones 502a, 502b or speakerphones and a microphone 504 that are housed in the earphones 102a and 102b and external microphone 106 of the headphone body 100, respectively. The external microphone 504 is capable of capturing sounds in the environment external to the headphones 100 to transmit to the headphone audio interface 510. Wires 506a, 506b, 506c disposed within the headphone 100 and bridge structures 104 connect the earphones 502a, 502b and microphone 504 to the headphone audio interface 510 comprising the electrical components housed in the headphone audio interface 118. The wires 506a, 506b, 506c may comprise cables suitable for transmitting audio signals and other data. In an alternative embodiment, wireless connection technologies may be used to connect the earphones 502a, 502b and microphone 504 to the headphone audio interface 510. The headphone electrical components 500 may include additional ports, such as the audio port 110 and port 108 in FIG. la to receive audio signals from an external device, such as an audio player, audio-video device, game console, telephone, etc.

FIG. 6 illustrates an embodiment of electrical components of a sound module 600, such as the sound modules 200, 300, and 400. The sound module 600 includes a module audio interface 602 comprising the electrical components housed in the module audio interface 222, 322, and 422; a boom microphone 604 housed in microphone 430 into which a person wearing the headphones 100 engaged to the sound module 200, 300, 400 can speak; an external microphone 605 to capture sounds from the environment external to the sound module 600, which may be housed in external microphone 212 (FIG. 2a); a port 606, such as the wire out port 432 through which data may be communicated with an external device, such as a game console, smartphone, multi-media player, etc.; a user interface 608 that may include the audio controls 204, 206, 208, 210, 302, 304, 308, 306, 404, 406, 408; a controller 610 comprising processing logic to perform sound module 600 operations; a memory 612 that may have an audio player 614 to render content from audio files 616 stored in the memory 612 or on a flash memory card 312, and settings 618 set through the user interface 608 controls; a remote audio interface 620 to transmit audio signals with an external device, such as a game console, smartphone, media player, etc.; and a memory card reader 622 having the electrical components housed in the card reader 310 (FIG. 3) to read audio content stored on a flash memory card 312 (FIG. 3).

The remote audio interface 620 may implement a wireless technology, such as Bluetooth®, and/or implement electrical components to interface with a connection to the port 606 to allow data communication with an external device.

The controller 610 may comprise a microprocessor that executes program code in the controller 610, such as firmware, or the memory 612. Alternatively, the controller 610 may comprise an Application Specific Integrated Circuit (ASIC) implementing the program code and memory 612.

In different embodiments, the sound module 600 may include any combination of the components for producing audio signals, such as microphones 604, 605, port 606, interface 620, audio player 614, and card reader 622. Further, different sound modules may be provided for attachment to the headphone attachment interface having different groups of the components 604, 605, 606, 620, 614, and 622.

The headphones 500 include auxiliary audio sources, such as, by way of example, but not limited to, the external microphone 504, external ports 108, 110, etc. The sound module 600 may have auxiliary audio sources too, such as the external microphone 212, 605. These auxiliary audio sources provide audio signals in addition to audio signals being generated by a module audio source in the sound module 600, such as the boom microphone 605, an audio player 614, memory card reader 622, and remote audio interface 620 providing audio signals from an external device, such as a game console or audio-visual device. Alternatively, the external microphone 605 may be treated as a module audio source instead of an auxiliary audio source for purposes of selecting between sound sources.

The controller 610 may perform different operations depending on the functionality of the sound module 200, 300, 400. For instance, the controller 610 for the sound module 200 may include logic for controlling audio content play in an external audio player, whereas the controller 610 in the sound module 400 may additionally include logic for processing input from the retractable boom microphone 430. The controller 610 includes logic for selecting audio signals to process from different combinations of audio sources that may be implemented in the sound module 600, such as audio signals received over the remote audio interface 620 and port 606 from an external device, audio signals generated from the audio player 614, audio signals captured by the microphone 604, 605, as well as audio signals captured by the headphone microphone 504 and other headphone audio sources.

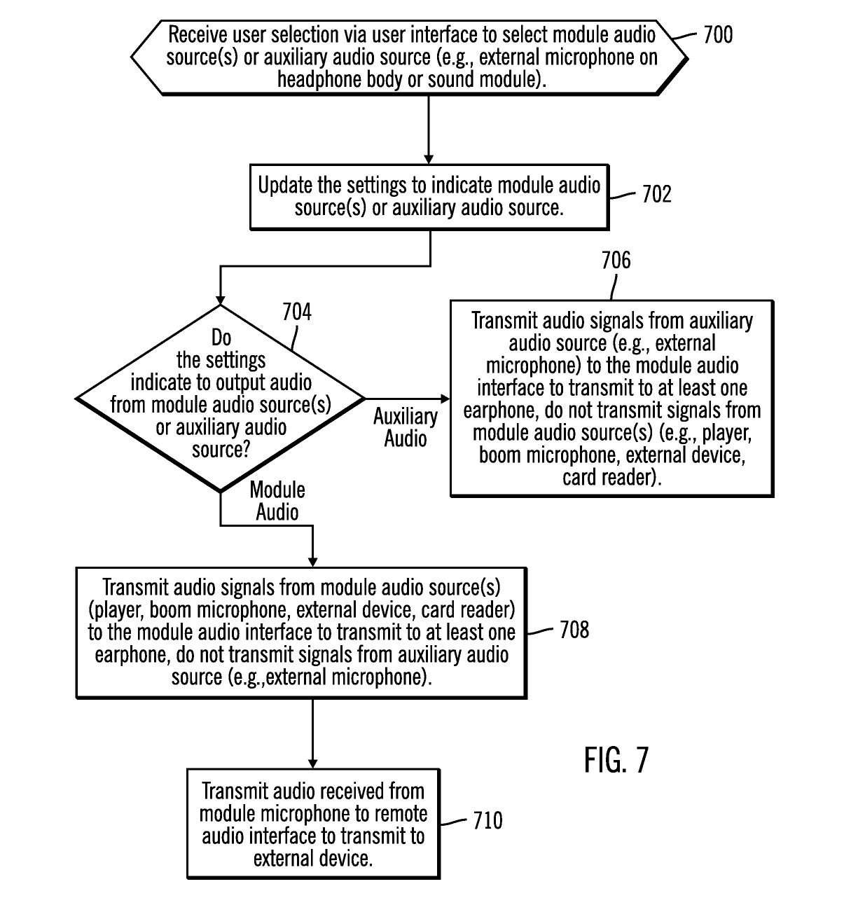

FIG. 7 illustrates an embodiment of operations performed by the controller 610 to process input from the user interface 608 to select either the module audio sources (e.g., 604, 606, 612, 614, 620, 622) or an auxiliary audio source (e.g., 106, 108, 110, 504, 605). Upon receiving (at block 700) user selection via the user interface 600 to select either a module audio source or the auxiliary audio source the controller 610 updates (at block 702) the settings 618 to indicate the user selection. For instance, in certain embodiments, the user may depress the scroll button 202, 302 or 402 to toggle between selecting the module audio source or auxiliary audio source.

If (at block 704) the settings 618 indicate to output and play audio from the auxiliary audio source, then the controller 610 transmits (at block 706) audio signals from the auxiliary audio source (e.g., headphone microphone 504) to the module audio interface 602 to transmit to at least one earphone 502a, 502b, 102a, 102b. The controller 610 may not transmit audio signals from the module audio source (e.g., 604, 606, 612, 614, 620, 622). For instance, if the user is listening to audio through the module audio source, which may be from the player 614 or an external device, and then selects the user interface 608 to switch to the headphone microphone 504, then the controller 610 would transmit to the earphones 502a, 502b audio from the headphone microphone 504 and stop transmitting audio from the module audio source. The controller 610 may block audio signals from the module audio source to prevent transmission or pause the playing of audio signals from the module audio source to restart when the user selects the user interface 608 again to select the module audio source. In this way, if someone near the user of the headphones 100 starts speaking to the user, the user may select the user interface 608 to transmit audio signals detected from the adjacent external environment by the headphone microphone 605 and stop listening to audio from the module audio source.

If (at block 704) the settings 618 indicate to output audio from the module audio source, then the controller 610 transmits (at block 708) audio signals from the one or more module audio sources producing audio to the module audio interface 602 to transmit to at least one earphone 502a, 502b, and does not transmit signals from the headphone audio source 504. For instance, if the user is listening to audio from the external environment through the headphone microphone 504 and wants to switch to listening to audio through the module audio source, which may be from the player 614 or an external device, then the user would use the user interface 608 to switch to the module audio source to transmit to the earphones 502a, 502b and stop transmitting audio from the headphone audio source, e.g., 504. The controller 610 may block audio signals from the auxiliary audio source to prevent transmission. Further, the controller 610 may transmit (at block 710) audio received from the module microphone 604, such as the boom microphone 430 in FIGS. 4a, 4b, 4c, to the remote audio interface 620 to transmit to the external device as well as the earphones 502a, 502b.

In an alternative embodiment, instead of stopping audio signals from the auxiliary audio source or module audio source that is not selected, the controller 610 may play the audio at a very low volume so it is heard in the background with respect to the audio from the selected module or auxiliary audio source.

Described embodiments provide headphones allowing for the attachment of one or more removably attachable sound modules that may provide audio signals to the headphones. The sound module has a controller to transmit audio signals from an audio source of the sound module to the headphone earphones. Further, in embodiments where there are auxiliary audio sources, such as an external microphone on the headphone body, the user may select to transmit to the earphones either audio from the sound module or the auxiliary audio source. Further, there may be sound modules having different functionality, such as a sound module capable of playing audio files stored in the sound module or a flash memory card inserted in the sound module or a sound module having a microphone to transmit audio from the wearer of the headset to an external device. The user may then select removably attachable modules to the headset to attach to the headset depending on the particular use the user of the headset wants to select.

The described operations of the controller may be implemented as a method, apparatus or computer readable storage medium using standard programming and/or engineering techniques to produce software, firmware, hardware, or any combination thereof The described operations may be implemented as code or logic maintained in a “computer readable storage medium”, which may directly execute the functions or where a processor may read and execute the code from the computer storage readable medium. The computer readable storage medium includes at least one of electronic circuitry, storage materials, inorganic materials, organic materials, biological materials, a casing, a housing, a coating, and hardware. A computer readable storage medium may comprise, but is not limited to, a magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), Solid State Devices (SSD), etc. The computer readable storage medium may further comprise digital logic implemented in a hardware device (e.g., an integrated circuit chip, a programmable logic device, a Programmable Gate Array (PGA), field-programmable gate array (FPGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The program code embedded on a computer readable storage medium may be transmitted as transmission signals from a transmitting station or computer to a receiving station or computer. A computer readable storage medium is not comprised solely of transmission signals, but includes tangible components, such as hardware elements. Those skilled in the art will recognize that many modifications may be made to this configuration without departing from the scope of the present invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Terms such as “top”, bottom”, “upper”, “lower”, “rear”, “front”, “back”, “outer”, “inner”, “bottom”, “left”, “right”, and the like may be used for descriptive purposes only and are not to be construed as limiting. Embodiments may be manufactured, used, and contained in a variety of positions and orientations.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The illustrated operations of the figures show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

### EXAMPLES

The following are examples of embodiments.

Example 1 is a headphone apparatus to connect with a sound producing module, comprising: a first earphone; a second earphone; an attachment interface to provide removable attachment with the sound module; an audio interface to couple with the sound module when the sound module is coupled to the attachment interface; an audio communication interface electrically coupled to the first earphone, the second earphone, and the audio interface to communicate audio signals from the sound module coupled to the attachment interface and the audio interface.

In Example 2, the subject matter of Examples 1 and 3-6 can optionally include that the audio communication interface comprises: a first transmission line to connect the audio interface to the first earphone to transmit audio signals from the sound module to the first earphone; and a second transmission line to connect the audio interface to the second earphone to transmit audio signals from the sound module to the second earphone.

In Example 3, the subject matter of Examples 1, 2 and 4-6 can optionally include an audio source, wherein the audio communication interface electrically couples the audio source to the audio interface to enable transmission of audio signals received at the audio source to the sound module.

In Example 4, the subject matter of Examples 1-3, 5, and 6 can optionally include that the audio source comprises a microphone located on an outer surface of the first earphone.

In Example 5, the subject matter of Examples 1-4 and 6 can optionally include that an inner side of the first earphone couples to an ear and wherein the audio interface and the attachment interface are located at an outer side of the first earphone.

In Example 6, the subject matter of Examples 1-5 can optionally include that the attachment interface comprises a substantially flat first surface of the outer side of the first earphone to which the sound module is removably attached, and wherein the audio interface is located on a second surface orthogonal with respect to the first surface, wherein an audio interface of the sound module is coupled to the audio interface on the second surface when the sound module is attached to the attachment interface on the flat surface.

Example 7 is headphone system, comprising: a sound module having a module attachment interface, a module audio interface, and a controller; and a headphone body comprising: a first earphone; a second earphone; a headphone attachment interface to provide removable attachment with the module attachment interface; a headphone audio interface to couple with the module audio interface when the module attachment interface is engaged with the headphone attachment interface, wherein the headphone audio interface communicates audio signals from the sound module to the first earphone and the second earphone when the module attachment interface is engaged with the headphone attachment interface and when the module audio interface is electrically coupled to the headphone audio interface, wherein the controller of the sound module causes operations to be performed, the operations comprising transmitting audio signals from the sound module to the module audio interface to further transmit to the headphone audio interface which transmits to at least one of the first and second earphones via the headphone audio interface.

In Example 8, the subject matter of Examples 7 and 9-14 can optionally include a headphone audio source on the headphone body, wherein the headphone audio interface electrically couples the headphone audio source to the sound module to transmit audio signals received at the headphone audio source to the sound module, wherein the operations performed by the controller further comprise: receiving audio signals from the headphone audio source; and transmitting the received audio signals from the headphone audio source to the module audio interface to transmit to at least one of the first and second earphones over the headphone audio interface.

In Example 9, the subject matter of Examples 7, 8 and 10-14 can optionally include a module audio source in the sound module for producing audio signals transmitted to the module audio interface to transmit to the headphone audio interface to transmit to at least one of the first and second earphones; and an auxiliary audio source to produce auxiliary audio signals, wherein the auxiliary audio signals received from the auxiliary audio source are transmitted to the sound module, and wherein the operations performed by the controller further comprise: receiving audio signals from the module audio source and the auxiliary audio source; and selecting to transmit audio signals from one of the module audio source or the auxiliary audio source to transmit to at least one of the first and second earphones via the module audio interface.

In Example 10, the subject matter of Examples 7-9 and 11-14 can optionally include that the auxiliary audio source comprises at least one external microphone to transmit sounds from an environment external to the headphone system, and wherein the at least one external microphone is located on at least one of the head the headphone body and the sound module.

In Example 11, the subject matter of Examples 7-10 and 12-14 can optionally include that the module audio source comprises at least one of an audio player to play audio files, a remote audio interface to receive audio transmitted from an external device, an additional microphone to capture audio signals from a user of the sound module, and a storage interface port to engage a storage device to read sound files on the storage device to play in an audio player in the sound module.

In Example 12, the subject matter of Examples 7-10 and 12-14 can optionally include that the sound module includes a user interface enabling selection of one of a first setting and a second setting, wherein the controller selects the module audio source to transmit in response to selection of the first setting and selects the auxiliary audio source to transmit in response to selection of the second setting.

In Example 13, the subject matter of Examples 7-12 and 14 can optionally include that when the first setting is selected, audio signals from the auxiliary audio source are not transmitted to the module audio interface and wherein when the second setting is selected audio signals from the module audio source are not transmitted to the module audio interface to transmit to the first and second earphones.

In Example 14, the subject matter of Examples 7-13 can optionally include at least one additional sound module, each additional sound module comprises a module attachment interface and a module audio interface, wherein each of the sound modules are capable of being separately attached to the headphone attachment interface and removed from being attached to the headphone attachment interface.

Example 15 is sound module for coupling with a headphone having a first earphone, a second earphone, a headphone attachment interface and a headphone audio interface, comprising: a sound module attachment interface designed to removably attach to the headphone attachment interface; a sound module audio interface to couple with the headphone audio interface when the sound module attachment interface is engaged with the headphone attachment interface; a module audio source for producing audio signals; and a controller for performing operations, the operations comprising transmitting audio signals from the module audio source through the sound module audio interface to the headphone audio interface to transmit to at least one of the first and second earphones.

In Example 16, the subject matter of Examples 15 and 17-22 can optionally include that the module audio source comprises at least one of an audio player to play audio files, a remote audio interface to receive audio transmitted from an external device, an additional microphone to capture audio signals from a user of the sound module, and a storage interface port to engage a storage device to read sound files on the storage device to play in an audio player in the sound module.

In Example 17, the subject matter of Examples 15, 16 and 18-22 can optionally be in communication with an auxiliary audio source to transmit sounds to the sound module, wherein the controller further performs operations, the operations comprising: receiving audio signals from the auxiliary audio source; and transmitting the audio signals from the auxiliary audio source to the sound module audio interface to transmit to at least one of the first and second earphones.

In Example 18, the subject matter of Examples 15-17 and 19-22 can optionally include that the operations performed by the controller further comprise: selecting to transmit audio signals from one of the module audio source or the auxiliary audio source to transmit to at least one of the first and second earphones via the module audio interface.

In Example 19, the subject matter of Examples 15-18 and 20-22 can optionally include that the module audio source comprises: a microphone to capture audio signals from a user of the sound module; and a remote audio interface in communication with an external device, wherein the operations performed by the controller further comprise: receiving audio signals from the microphone and the remote audio interface, wherein when the module audio source is selected, the controller transmits audio signals from the microphone to the external device and to at least one of the first and second earphones and transmits audio signals from the external device to the least one of the first and second earphones.

In Example 20, the subject matter of Examples 15-19, 21, and 22 can optionally include that the auxiliary audio source comprises at least one external microphone to transmit sounds from an environment external to the headphone system, and wherein the at least one external microphone is located on at least one of the head the headphone body and the sound module.

In Example 21, the subject matter of Examples 15-20 and 22 can optionally include that the sound module includes a user interface enabling selection of one of a first setting and a second setting, wherein the controller selects the module audio source to transmit in response to selection of the first setting and selects the auxiliary audio source to transmit in response to selection of the second setting.

In Example 22, the subject matter of Examples 15-21 can optionally include that when the first setting is selected, audio signals from the auxiliary audio source are not transmitted to the module audio interface and wherein when the second setting is selected audio signals from the module audio source are not transmitted to the module audio interface to transmit to the first and second earphones.

Example 23 is a headphone system, comprising: a sound module, comprising: a module interface; a controller; a user interface enabling selection of one of a first setting and a second setting; a module audio source to generate audio signals; a headphone body comprising: a first earphone; a second earphone; a headphone audio interface to couple with the module audio interface, the first earphone, the second earphone, to communicate audio signals from the sound module; at least one external microphone located on at least one of the sound module and the headphone body, wherein the at least one external microphone transmits sounds from an environment external to the headphone system to the sound module, wherein the controller of the sound module performs operations, the operations comprising: receiving audio signals from the module audio source and the external microphone; and selecting to transmit audio signals from one of the module audio source or the external microphone to transmit to at least one of the first and second earphones via the module audio interface.

In Example 24, the subject matter of Examples 23 and 25 can optionally include the module audio source comprises at least one of an audio player to play audio files, a remote audio interface to receive audio transmitted from an external device, and a storage interface port to engage a storage device to read sound files to play in an audio player in the sound module stored on a storage device coupled to a card reader.

In Example 25, the subject matter of Examples 23 and 24 can optionally include the sound module includes a user interface enabling selection of one of a first setting and a second setting, wherein the controller selects the module audio source to transmit in response to selection of the first setting and selects the external microphone to transmit in response to selection of the second setting.

Example 26 is a method for using headphone system, comprising: attaching a sound module, having a module attachment interface, a module audio interface, and a controller, to a headphone attachment interface of a headphone body providing removable attachment with the module attachment interface, wherein the headphone body further includes a first earphone, a second earphone, and a headphone audio interface that is coupled with the module audio interface when the module attachment interface is attached to the headphone attachment interface, wherein the headphone audio interface communicates audio signals from the sound module to the first earphone and the second earphone when the module attachment interface is engaged with the headphone attachment interface and when the module audio interface is electrically coupled to the headphone audio interface; causing the controller to transmit audio signals from the sound module to the module audio interface to further transmit to the headphone audio interface which transmits to at least one of the first and second earphones via the headphone audio interface.

In Example 27, the subject matter of Examples 26 and 28-35 can optionally include that the headphone body further includes a headphone audio source on the headphone body, wherein the headphone audio interface electrically couples the headphone audio source to the sound module to transmit audio signals received at the headphone audio source to the sound module, further comprising: causing the controller to receive audio signals from the headphone audio source; and causing the controller to transmit the received audio signals from the headphone audio source to the module audio interface to transmit to at least one of the first and second earphones over the headphone audio interface.

In Example 28, the subject matter of Examples 26, 27 and 29-35 can optionally include that the sound module includes a module audio source for producing audio signals transmitted to the module audio interface to transmit to the headphone audio interface to transmit to at least one of the first and second earphones, wherein an auxiliary audio source produces auxiliary audio signals, wherein the auxiliary audio signals received from the auxiliary audio source are transmitted to the sound module, and wherein the operations performed by the controller further comprise: causing the controller to receive audio signals from the module audio source and the auxiliary audio source; and causing the controller to select to transmit audio signals from one of the module audio source or the auxiliary audio source to transmit to at least one of the first and second earphones via the module audio interface.

In Example 29, the subject matter of Examples 26-28 and 30-35 can optionally include that the auxiliary audio source comprises at least one external microphone to transmit sounds from an environment external to the headphone system, and wherein the at least one external microphone is located on at least one of the head the headphone body and the sound module.

In Example 30, the subject matter of Examples 26-29 and 31-35 can optionally include that the module audio source comprises at least one of an audio player to play audio files, a remote audio interface to receive audio transmitted from an external device, an additional microphone to capture audio signals from a user of the sound module, and a storage interface port to engage a storage device to read sound files on the storage device to play in an audio player in the sound module.

In Example 31, the subject matter of Examples 26-30 and 32-35 can optionally include that the sound module includes a user interface enabling selection of one of a first setting and a second setting and module audio source, further comprising: selecting the first setting to cause the controller to select the module audio source to transmit; and selecting the second setting to cause the controller to select the auxiliary audio source to transmit.

In Example 32, the subject matter of Examples 26-31 and 33-35 can optionally include that when the first setting is selected, audio signals from the auxiliary audio source are not transmitted to the module audio interface and wherein when the second setting is selected audio signals from the module audio source are not transmitted to the module audio interface to transmit to the first and second earphones.

In Example 33, the subject matter of Examples 26-32, 34, and 35 can optionally include that the module audio source comprises a microphone to capture audio signals from a user of the sound module and a remote audio interface in communication with an external device, further comprising: causing the controller to receiving audio signals from the microphone and the remote audio interface, wherein when the module audio source is selected, the controller transmits audio signals from the microphone to the external device and to at least one of the first and second earphones and transmits audio signals from the external device to the least one of the first and second earphones.

In Example 34, the subject matter of Examples 26-33 and 35 can optionally include disengaging the module attachment interface from the headphone attachment interface to remove the sound module from the headphone body, and attaching at least one additional sound module to the headphone body, wherein each of the at least one additional sound module comprises at least one module audio source, a module attachment interface and a module audio interface, wherein each of the sound modules are capable of being separately attached to the headphone attachment interface and removed from being attached to the headphone attachment interface.

In Example 35, the subject matter of Examples 26-34 can optionally include that the method of any combination of claims 26-33 are performed for the at least one additional sound module.

Example 36 is an apparatus comprising means to perform a method as claimed in claims 26-35.

What is claimed:

1. A headphone apparatus to connect with a sound producing module, comprising:
a first earphone;
a second earphone;
an attachment interface to provide removable attachment with the sound module;
an audio interface to couple with the sound module when the sound module is coupled to the attachment interface;
an audio communication interface electrically coupled to the first earphone, the second earphone, and the audio interface to communicate audio signals from the sound module coupled to the attachment interface and the audio interface.

2. The headphone apparatus of claim 1, wherein the audio communication interface comprises:
a first transmission line to connect the audio interface to the first earphone to transmit audio signals from the sound module to the first earphone; and
a second transmission line to connect the audio interface to the second earphone to transmit audio signals from the sound module to the second earphone.

3. The headphone apparatus of claim 1, further comprising:
an audio source, wherein the audio communication interface electrically couples the audio source to the audio interface to enable transmission of audio signals received at the audio source to the sound module.

4. The headphone apparatus of claim 3, wherein the audio source comprises a microphone located on an outer surface of the first earphone.

5. The headphone apparatus of claim 1, wherein an inner side of the first earphone couples to an ear and wherein the audio interface and the attachment interface are located at an outer side of the first earphone.

6. The headphone apparatus of claim 5, wherein the attachment interface comprises a substantially flat first surface of the outer side of the first earphone to which the sound module is removably attached, and wherein the audio interface is located on a second surface orthogonal with respect to the first surface, wherein an audio interface of the sound module is coupled to the audio interface on the second surface when the sound module is attached to the attachment interface on the flat surface.

7. A headphone system, comprising:
a sound module having a module attachment interface, a module audio interface, and a controller; and
a headphone body comprising:
a first earphone;
a second earphone;
a headphone attachment interface to provide removable attachment with the module attachment interface
a headphone audio interface to couple with the module audio interface when the module attachment interface is engaged with the headphone attachment interface, wherein the headphone audio interface communicates audio signals from the sound module to the first earphone and the second earphone when the module attachment interface is engaged with the headphone attachment interface and when the module audio interface is electrically coupled to the headphone audio interface,
wherein the controller of the sound module causes operations to be performed, the operations comprising transmitting audio signals from the sound module to the module audio interface to further transmit to the headphone audio interface which transmits to at least one of the first and second earphones via the headphone audio interface.

8. The headphone system of claim 7, further comprising:
a headphone audio source on the headphone body, wherein the headphone audio interface electrically couples the headphone audio source to the sound module to transmit audio signals received at the headphone audio source to the sound module,
wherein the operations performed by the controller further comprise:
receiving audio signals from the headphone audio source; and
transmitting the received audio signals from the headphone audio source to the module audio interface to transmit to at least one of the first and second earphones over the headphone audio interface.

9. The headphone system of claim 7, further comprising:
a module audio source in the sound module for producing audio signals transmitted to the module audio interface to transmit to the headphone audio interface to transmit to at least one of the first and second earphones; and
an auxiliary audio source to produce auxiliary audio signals, wherein the auxiliary audio signals received from the auxiliary audio source are transmitted to the sound module, and
wherein the operations performed by the controller further comprise:
receiving audio signals from the module audio source and the auxiliary audio source; and
selecting to transmit audio signals from one of the module audio source or the auxiliary audio source to transmit to at least one of the first and second earphones via the module audio interface.

10. The headphone system of claim 9, wherein the auxiliary audio source comprises at least one external microphone to transmit sounds from an environment external to the headphone system, and wherein the at least one external microphone is located on at least one of the head the headphone body and the sound module.

11. The headphone system of claim 9, wherein the module audio source comprises at least one of an audio player to play audio files, a remote audio interface to receive audio transmitted from an external device, an additional microphone to capture audio signals from a user of the sound module, and a storage interface port to engage a storage device to read sound files on the storage device to play in an audio player in the sound module.

12. The headphone system of claim 9 wherein the sound module includes a user interface enabling selection of one of a first setting and a second setting, wherein the controller selects the module audio source to transmit in response to selection of the first setting and selects the auxiliary audio source to transmit in response to selection of the second setting.

13. The headphone system of claim 12, wherein when the first setting is selected, audio signals from the auxiliary audio source are not transmitted to the module audio interface and wherein when the second setting is selected audio signals from the module audio source are not transmitted to the module audio interface to transmit to the first and second earphones.

14. The headphone system of claim 7, further comprising:
at least one additional sound module, each additional sound module comprises a module attachment interface and a module audio interface, wherein each of the sound modules are capable of being separately attached to the headphone attachment interface and removed from being attached to the headphone attachment interface.

15. A sound module for coupling with a headphone having a first earphone, a second earphone, a headphone attachment interface and a headphone audio interface, comprising:
a sound module attachment interface designed to removably attach to the headphone attachment interface;
a sound module audio interface to couple with the headphone audio interface when the sound module attachment interface is engaged with the headphone attachment interface;
a module audio source for producing audio signals; and
a controller for performing operations, the operations comprising transmitting audio signals from the module audio source through the sound module audio interface to the headphone audio interface to transmit to at least one of the first and second earphones.

16. The sound module of claim 15, wherein the module audio source comprises at least one of an audio player to play audio files, a remote audio interface to receive audio transmitted from an external device, an additional microphone to capture audio signals from a user of the sound module, and a storage interface port to engage a storage device to read sound files on the storage device to play in an audio player in the sound module.

17. The sound module of claim 15 in communication with an auxiliary audio source to transmit sounds to the sound module,
wherein the controller further performs operations, the operations comprising:
receiving audio signals from the auxiliary audio source; and
transmitting the audio signals from the auxiliary audio source to the sound module audio interface to transmit to at least one of the first and second earphones.

18. The sound module of claim 17, wherein the operations performed by the controller further comprise:
selecting to transmit audio signals from one of the module audio source or the auxiliary audio source to transmit to at least one of the first and second earphones via the module audio interface.

19. The sound module of claim 17, wherein the module audio source comprises:
a microphone to capture audio signals from a user of the sound module; and
a remote audio interface in communication with an external device,
wherein the operations performed by the controller further comprise:
receiving audio signals from the microphone and the remote audio interface, wherein when the module audio source is selected, the controller transmits audio signals from the microphone to the external device and to at least one of the first and second earphones and transmits audio signals from the external device to the least one of the first and second earphones.

20. The sound module of claim 17, wherein the auxiliary audio source comprises at least one external microphone to transmit sounds from an environment external to the headphone system, and wherein the at least one external microphone is located on at least one of the head the headphone body and the sound module.

21. The module audio source of claim 17 wherein the sound module includes a user interface enabling selection of one of a first setting and a second setting, wherein the controller selects the module audio source to transmit in response to selection of the first setting and selects the auxiliary audio source to transmit in response to selection of the second setting.

22. The module audio source of claim 21, wherein when the first setting is selected, audio signals from the auxiliary audio source are not transmitted to the module audio interface and wherein when the second setting is selected audio signals from the module audio source are not transmitted to the module audio interface to transmit to the first and second earphones.

23. A headphone system, comprising:
a sound module, comprising:
a module interface;
a controller;
a user interface enabling selection of one of a first setting and a second setting;
a module audio source to generate audio signals;
a headphone body comprising:
a first earphone;
a second earphone;
a headphone audio interface to couple with the module audio interface, the first earphone, the second earphone, to communicate audio signals from the sound module;
at least one external microphone located on at least one of the sound module and the headphone body, wherein the at least one external microphone transmits sounds from an environment external to the headphone system to the sound module,
wherein the controller of the sound module performs operations, the operations comprising:
receiving audio signals from the module audio source and the external microphone; and
selecting to transmit audio signals from one of the module audio source or the external microphone to transmit to at least one of the first and second earphones via the module audio interface.

24. The headphone system of claim 23, wherein the module audio source comprises at least one of an audio player to play audio files, a remote audio interface to receive audio transmitted from an external device, and a storage interface port to engage a storage device to read sound files to play in an audio player in the sound module stored on a storage device coupled to a card reader.

25. The headphone system of claim 23, wherein the sound module includes a user interface enabling selection of one of a first setting and a second setting, wherein the controller selects the module audio source to transmit in response to selection of the first setting and selects the external microphone to transmit in response to selection of the second setting.
